(19) United States
(12) Patent Application Publication
(10) Pub. No.: US 2008/0236356 A1
(43) Pub. Date: Oct. 2, 2008

(54) PUNCHING DEVICE

(75) Inventors: KUO-JUNG HUANG, Tu-Cheng (TW); SHU-WEI ZHOU, Shenzhen (CN); FU-SHUN HUANG, Tu-Cheng (TW); CHUN-NAN OU, Tu-Cheng (TW); CHIA-HSIANG OU, Tu-Cheng (TW); YUN-FENG ZHANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/061,612

(22) Filed: Apr. 2, 2008

(30) Foreign Application Priority Data
Apr. 2, 2007 (TW) 96111581

(51) Int. Cl. B26F 1/04; B21D 28/34

(52) U.S. Cl. 83/542; 83/590; 83/582; 83/698.91

(57) ABSTRACT

A punching device comprises a pushing pole, an adjusting portion, a supporting portion, and a spring. The pushing pole comprises a first threaded end and a second threaded end. The adjusting portion defines a screw hole therein, through which the adjusting portion is fixed to the first end of the pushing pole. The supporting portion is located on the pushing pole, with the pushing pole passing through a through hole in the supporting portion. The spring is disposed around the pushing pole, with two ends respectively abutting against the adjusting portion and the supporting portion.

### BACKGROUND

1. Field of the Invention

The present invention relates to punching devices, specifically to a punching device having adjustable resilience.

2. Description of Related Art

Generally, a resilient element, such as a spring, is placed in a punching device for protecting the punching device from serious and/or excessive vibration and further to avoid damaging workpieces during punching.

During production, a punching device needs to punch all kinds of parts with various hardness or different machining requirements. Punching a different part needs to change a different punching component with a different level of resilience, it will take time and increase production cost when changing punching components is necessary and frequent.

Therefore, a heretofore unaddressed need exists in the industry to address the aforementioned deficiencies and inadequacies.

### SUMMARY

According to an exemplary embodiment of the present invention, a punching device comprises a pushing pole, a supporting portion, an adjusting portion, and a spring. The pushing pole comprises a pole body and a flange. The pole body comprises a first threaded end and a second end. The flange is fixed on the pole body between the first end and the second end. The supporting portion is located on the pushing pole between the flange and the first end. The adjusting portion is fixed on the first end of the pushing pole, which defines a screw hole therein. The spring is disposed around the pushing pole between the supporting portion and the adjusting portion.

The adjusting portion defines at least one positioning hole extending along the radial direction thereof, and the positioning hole communicates with the screw hole. The first end defines at least one groove extending along an axial direction of the pole body, and a first positioning pin is adapted for passing through the positioning hole and engaging with the groove. The supporting portion defines a stop hole extending along a radial direction thereof, the pole body defines a slot communicating with the stop hole, and a second positioning pin passes through the stop hole and is received in the slot. The adjusting portion comprises an axle sleeve matching with the spring in a clearance fit.

According to another exemplary embodiment of the present invention, a punching assembly comprises a punching equipment, a punching device, and a punch. The punching equipment comprises a hammer, a supporting platform opposite to the hammer, and a pressing block disposed on the supporting platform for pressing a workpiece. The punching device comprises a pushing pole, a supporting portion, an adjusting portion and a spring. The pushing pole comprises a pole body and a flange. The pole body comprises a first threaded end and a second end. The flange is fixed on the pole body between the first end and the second end. The supporting portion is located on the pushing pole between the flange and the first end. The adjusting portion is fixed on the first end of the pushing pole which defines a screw hole therein. The spring is disposed around the pushing pole between the supporting portion and the adjusting portion.

Other advantages and novel features will become more apparent from the following detailed description when taken in conjunction with the accompanying drawings, in which:

### BRIEF DESCRIPTION OF THE DRAWINGS

FIG. 1 is an assembled view of a punching device in accordance with an exemplary embodiment;

FIG. 2 is a perspective view of an adjusting portion of the punching device of FIG. 1;

FIG. 3 is a perspective view of a supporting portion of the punching device of FIG. 1;

FIG. 4 is a perspective view of a pushing pole of the punching device of FIG. 1;

FIG. 5 is an exploded view of the punching device of FIG. 1; and

FIG. 6 is a schematic view of a punching assembly comprising the punching device of FIG. 1.

### DETAILED DESCRIPTION OF THE EMBODIMENTS

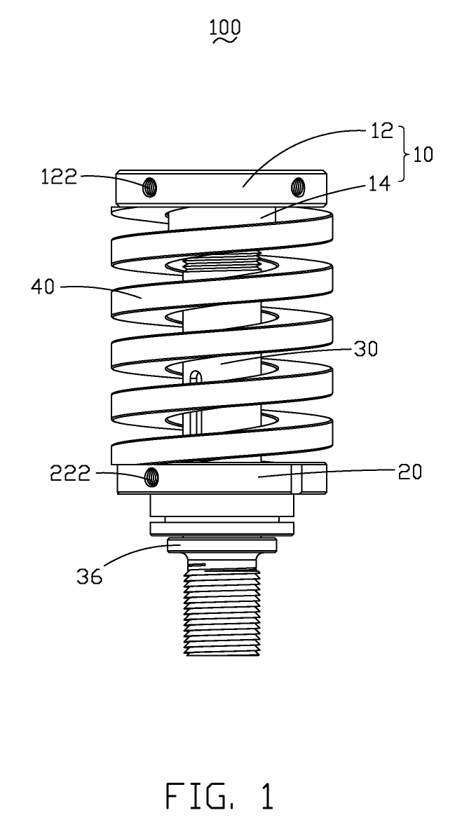

Referring to FIG. 1, a punching device 100 comprises a pushing pole 30, an adjusting portion 10 fixed on the pushing pole 30, a supporting portion 20 fixed on the pushing pole 30 opposite to the adjusting portion 10, and an elastic element like a spring 40 disposed around the pushing pole 30 and between the adjusting portion 10 and the supporting portion 20. In this embodiment, two ends of the spring 40 abut against the adjusting portion 10 and the supporting portion 20. In other embodiments, one end of the spring 40 may be configured to not abut against the corresponding one of the adjusting portion 10 and the supporting portion 20 when the punching device 100 is not working.

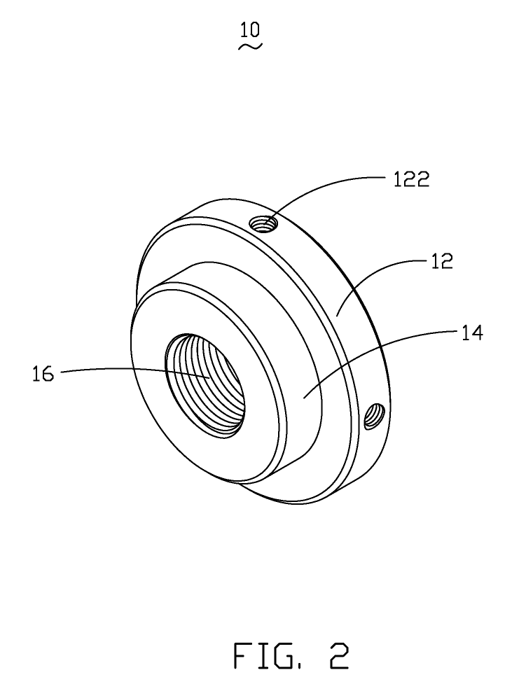

Referring to FIG. 2, the adjusting portion 10 comprises an adjusting block 12, and an adjacent axle sleeve 14 coaxial to the adjusting block 12. In this embodiment, the axle sleeve 14 is integrally formed with the adjusting block 12, and the outer diameter of the axle sleeve 14 is less than that of the adjusting block 12. Also referring to FIG. 1, one end of the spring 40 is disposed around the axle sleeve 14. In this embodiment, the spring 40 mates with the axle sleeve 14 in a clearance fit. A screw hole 16 is defined in the adjusting portion 10 along an axial direction thereof, and two positioning holes 122 are defined in the adjusting block 12 in communication with the screw hole 16. In this embodiment, the two positioning holes 122 are screw holes, and the angle between the two positioning holes 122 is about 90 degree.

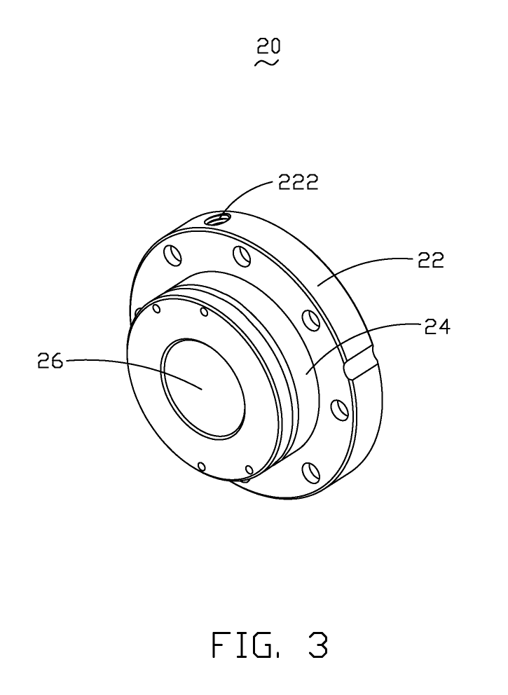

Referring to FIG. 3, the supporting portion 20 comprises a supporting block 22 and an axle sleeve 24 that is coaxial to the supporting block 22. In this embodiment, the axle sleeve 24 is integrally formed with the supporting block 22. The outer diameter of the axle sleeve 24 is less than that of the supporting block 22. A through hole 26 is defined in the supporting portion 20 along the axial direction thereof. A stop hole 222 is defined in the supporting block 22 along the radial direction thereof. In this embodiment, the stop hole 222 is a screw hole in communication with the through hole 26.

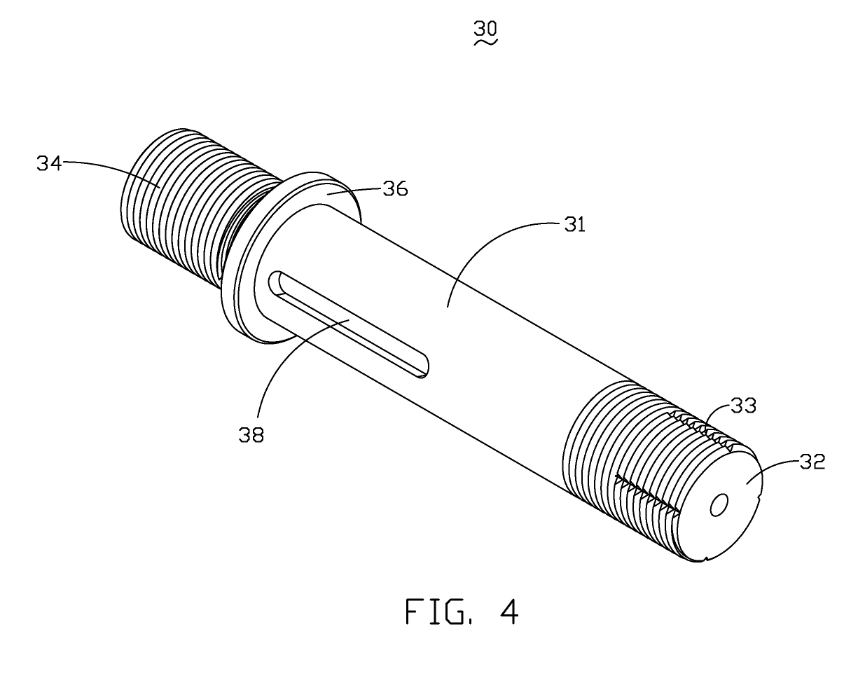

Referring to FIG. 4, the pushing pole 30 comprises a pole body 31 and a flange 36. The pole body 31 comprises a first threaded end 32 and a second threaded end 34. Four grooves 33 extending along the axial direction of the pole body 31 are arranged in the threaded portion of the first end 32. The flange 36 is fixed between the first end 32 and the second end 34 on the pole body 31, and contiguous with the second end 34. A slot 38 extending along the axle of the pushing pole 30 is defined in the pole body 31 between the flange 36 and the first end 32, and the slot 38 is contiguous with the flange 36.

The flange 36 is annular and coaxial to the pole body 31. In other embodiments of the present invention, the flange 36 can also be rectangular, triangular, or in other shapes.

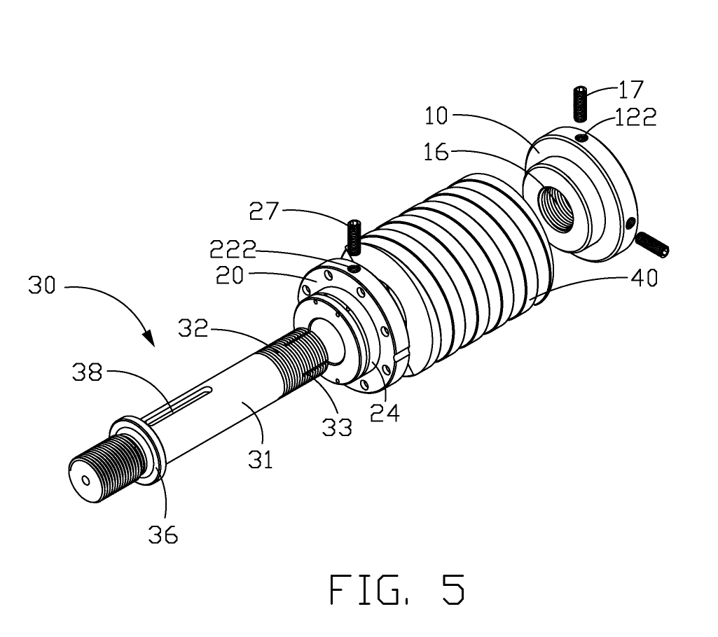

Referring to FIG. 4. and FIG. 5, the supporting portion 20 is fixed on the pushing pole 30 from the first end 32 of the pushing pole 30, the axle sleeve 24 of the supporting portion 20 is placed contiguous with the flange 36 of the pushing pole 30, and the stop hole 222 of the supporting portion 20 is in communication with the slot 38 of the pole body 31. A second positioning pin 27 is adapted for passing through the stop hole 222 and is received in the slot 38.

The spring 40 is disposed around the pushing pole 30 from the first end 32 of the pole body 31.

The screw hole 16 of the adjusting portion 10 receives the first threaded end 32 of the pole body 31. A first positioning pin 17 is adapted for passing through the positioning hole 122 and engaging in the groove 33. In this embodiment, the two ends of the spring 40 respectively abut against the adjusting portion 10 and the supporting portion 20, and the spring 40 is disposed around the axle sleeve 14 for support. When the punching device 100 of the present invention finishes a punching phase, the supporting portion 10 moves away from the supporting portion 20, until the flange 36 abuts against the supporting portion 20.

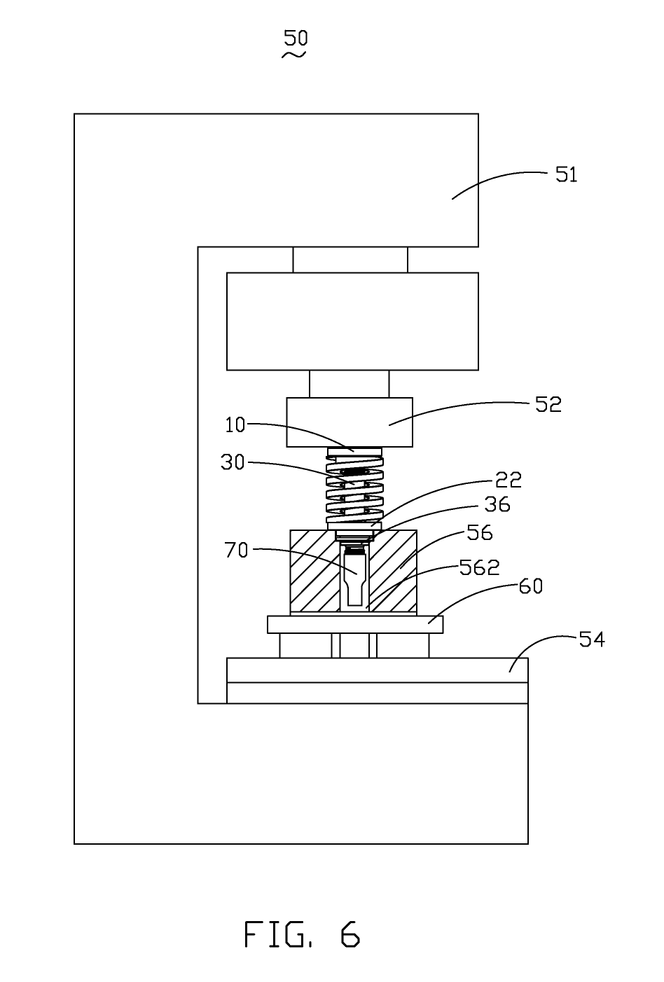

Referring to FIG. 6, a punching assembly 50 comprises punching equipment 51. The punching equipment 51 comprises a hammer 52 for providing punching power, and a supporting platform 54 opposite to the hammer 52. A workpiece 60 is placed on the supporting platform 54. A pressing block 56 having a through hole 562 presses the workpiece 60, and the pushing pole 30 can be received in the through hole 562. The diameter of the through hole 562 is less than the outer diameter of the supporting block 22, but larger than the outer diameter of the flange 36. A punch 70 is fixed at the second end 34 of the pushing pole 30. When the hammer 52 presses the adjusting portion 10, the punch 70 moves toward the workpiece 60 and punches it.

When the punching device 100 punches a workpiece having a different hardness or different machining requirements, the operator need only remove the first positioning pin 17, and adjust the distance between the adjusting portion 10 and the pushing pole 30 via rotating the adjusting portion 10, then the tension of the spring 40 is changed. Therefore, the resilience of the punching device 10 is changed.

When the spring 40 needs to be replace, the operator can easily remove the adjusting portion 10 from the pushing pole 30, and change the spring 40.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A punching device, comprising:
a pushing pole, comprising a pole body having a first threaded end and a second end, and a flange is fixed on the pole body between the first end and the second end;
a supporting portion is located on the pushing pole, between the flange and the first end;
an adjusting portion fixed on the first end of the pushing pole which defines a screw hole therein;
a spring disposed around the pushing pole, and between the supporting portion and the adjusting portion.

2. The punching device as claimed in claim 1, wherein the adjusting portion defines at least one positioning hole extending along the radial direction thereof, the positioning hole communicating with the screw hole.

3. The punching device as claimed in claim 2, wherein the first end defines at least one groove, thereby a first positioning pin is adapted for passing through the positioning hole and engaging in the groove.

4. The punching device as claimed in claim 3, wherein the groove extends along an axial direction of the pole body.

5. The punching device as claimed in claim 3, wherein the adjusting portion defines two positioning holes perpendicular to each other.

6. The punching device as claimed in claim 1, wherein the supporting portion defines a stop hole extending along a radial direction thereof, the pole body defines a slot in communicating with the stop hole, thereby, a second positioning pin is adapted for passing through the stop hole and is received in the slot.

7. The punching device as claimed in claim 1, wherein the flange is integrally formed with the pole body.

8. The punching device as claimed in claim 1, wherein the adjusting portion comprises an axle sleeve mating with the spring in a clearance fit.

9. A punching assembly, comprising:
a punching equipment, comprising a hammer, a supporting platform opposite to the hammer, and a pressing block disposed on the supporting platform for pressing a workpiece;
a punching device, comprising:
a pushing pole, comprising a pole body having a first threaded end and a second end, and a flange is fixed on the pole body between the first end and the second end;
a supporting portion is located on the pushing pole, between the flange and the first end;
an adjusting portion fixed on the first end of the pushing pole which defines a screw hole therein;
a spring disposed around the pushing pole, and between the supporting portion and the adjusting portion; and
a punch fixed on the second end of the pushing pole.

10. The punching assembly as claimed in claim 9, wherein the adjusting portion defines at least one positioning hole extending along the radial direction thereof, the positioning hole communicating with the screw hole.

11. The punching assembly as claimed in claim 10, wherein the first end defines at least one groove, thereby a first positioning pin is adapted for passing through the positioning hole and engaging in the groove.

12. The punching assembly as claimed in claim 11, wherein the groove extends along an axial direction of the pole body.

13. The punching assembly as claimed in claim 11, wherein the adjusting portion defines two positioning holes perpendicular to each other.

14. The punching assembly as claimed in claim 9, wherein the supporting portion defines a stop hole extending along a radial direction thereof, the pole body defines a slot in communicating with the stop hole, thereby, a second positioning pin is adapted for passing through the stop hole and is received in the slot.

15. The punching assembly as claimed in claim 9, wherein the flange is integrally formed with the pole body.

16. The punching assembly as claimed in claim 9, wherein the adjusting portion comprises an axle sleeve mating with the spring in a clearance fit.

17. A punching assembly, comprising:
a punching equipment comprising a supporting platform for placement of a workpiece, and a hammer spaced from said supporting platform for providing punching power toward said workpiece placed on said supporting platform; and
a punching device disposed between said hammer and said supporting platform so as to accept said punching power from said hammer for punching said workpiece, said punching device comprising a pushing pole extending and movable between said hammer and said supporting platform, an adjusting portion fixed at a first end of said pushing pole to engage with said hammer for accepting said punching power from said hammer and urge said pushing pole to move toward said workpiece, a punch fixed at a second end of said pushing pole opposite to said first end thereof to move together with said pushing pole for punching said workpiece, a supporting portion disposed beside said second end of said pushing pole to confine an elastic element around said pushing pole between said supporting portion and said adjusting portion, a relative fixed position of said adjusting portion onto said pushing pole being changeable so as to adjust resilience of said elastic element between said supporting portion and said adjusting portion.

18. The punching assembly as claimed in claim 17, wherein said first end of said pushing pole is a threaded end in order to engage with a screw hole of said adjusting portion.

19. The punching assembly as claimed in claim 17, wherein a positioning pin extending in said adjusting portion engages in a groove of said pushing pole so as to fix said adjusting portion onto said pushing pole.

20. The punching assembly as claimed in claim 17, wherein a positioning pin extending in said supporting portion engages in a slot of said pushing pole so as to guide movement of said pushing pole between said hammer and said supporting platform.
